(19) United States
(12) Patent Application Publication
(10) Pub. No.: US 2005/0177560 A1
(43) Pub. Date: Aug. 11, 2005

(54) Content management apparatus, content management method and content management program product

(76) Inventor: Yasuhiro Morioka, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/043,171

(22) Filed: Jan. 27, 2005

(30) Foreign Application Priority Data
Jan. 30, 2004 (JP) 2004-024472

(51) Int. Cl. G06F 7/00

(52) U.S. Cl. 707/3

(57) ABSTRACT

A content information management apparatus is coupled to content providing devices in a network. In this network, the content providing devices provide content information that is described in extensible mark up language (XML). Content information includes a declaration description in which a namespace with a prefix is declared. The content information management apparatus checks for pieces of content information received from the content providing devices in order to detect the occurrence of a prefix-duplication of namespace. A value of a prefix is so replaced that prefixes do not duplicate, and a namespace included in content information is reconstructed. The processed content information is linked with another content information, and the linked content information is managed in XML.

### CROSS-REFERENCE TO RELATED APPLICATIONS

This application is based upon and claims the benefit of priority from prior Japanese Patent Application No. 2004-024472, filed Jan. 30, 2004, the entire contents of which are incorporated herein by reference.

### BACKGROUND OF THE INVENTION

1. Field of the Invention

The present invention relates to a content management apparatus, a content management method, and a content management program product for management content information (meta data) on the content provided via a network.

2. Description of the Related Art

Instead of utilizing content such as a music or a picture (Audio/Video, hereinafter, referred to as “AV content”) by storing and managing them in a physical medium such as a video tape or a compact disk, there has been introduced a device for recording or playing back the AV content (hereinafter, referred to as an “AV device”) itself incorporating a hard disk, wherein AV content is recorded and maintained.

Further, there have been introduced the AV devices connected to one another via a network to enable search or operation of content from another device or movement, copying, and playback of content across the devices. For example, transmission between the AV devices using an IEEE (The Institute of Electrical and Electronics Engineers) 1394 scheme serial bus and transmission using an IEEE 802 scheme network and a TCP/IP protocol have been developed.

UPnP (Universal Plug and Play) A/V standard offers a frame of universal AV device linkage. For the UPnP, reference is made to “MediaServer: 1 Device Template Version 1.01 For Universal Plug and Play Version 1.0, Status: Standardized DCP, Date: Jun. 25, 2002”, www.upnp.org/standardizeddcps/mediaserver.asp, which is incorporated herein by reference.

A procedure relating to inquire and playback/recording of the AV content and a standard relating to description of content information are ruled on a basic service defined under the UPnP specification. According to the UPnP A/V content directory service (CDS: Content Directory Service), there are unified methods for inquiring content information possessed by an AV device or generating, deleting, and updating the content information relevant to such an AV device.

When the AV content is utilized over a network based on the UPnP A/V, it is considered that an added value is provided by interposed another device. For example, a content data format provided by one AV device is provided by converting it in another data format or the pieces of content information managed by a plurality of AV devices are integrally managed and are published.

In fact, manufacturers or service providers will add unique information to standard content information defined under the UPnP A/V. In the UPnP A/V, XML (extensible Markup Language) is adopted for describing the standard content defined under the UPnP A/V, and the technique of namespace is also utilized. The skilled in the art will easily recognize that an XML namespace is declared by a unique URI, and is identified from another. There is a merit that registration and management of the namespace itself are eliminated by using a unique URI. With respect to an element (or attribute) described together with a namespace defined under the UPnP A/V as a standard, and an element (or attribute) described together with a (non-standard) namespace uniquely defined for additional information, namespaces can be identified from each other, thus avoiding collision between the namespaces.

For example, in the case where the pieces of content information managed by a plurality of AV devices are integrated managed and provided, a technique called DOM (Document Object Model) is utilized to collect and process the pieces of content information which exist in a plurality of devices in a dispersed manner. For the DOM, reference is made to “Document Object Model (DOM) Level 2 Core Specification Version 1.0 W3C Recommendation 13 Nov., 2000”, www.w3.org/TR/DOM-Level-2-Core/core.html, which is incorporated herein by reference.

A DOM processor provides an operating interface in which an XML description is shown as a tree structure. The pieces of content information acquired from devices are linked with each other by utilizing an importNode method of the DOM, and a content information tree is formed. The content information for use in CDS of the UPnP A/V is also described in XML, and a namespace declaration used in the XML description is placed on and belongs to the most significant node of the DOM-expressed content information tree.

When the pieces of content information acquired from devices are linked with each other by the DOM, if the namespace declaration description of each item of content information is extracted and placed on the most significant node of the content tree information as is, a problem will occur. As described above, collision of elements or attributes in the XML description of the content information can be avoided by utilizing XML namespaces. In addition, a namespace itself can be discriminated from another by the URI. However, there may be a case wherein a prefix for use in specifying a namespace overlaps another one, although the URI is different. This is likely to occur when the XML descriptions of content information from different providing sources are linked with each other. The prefix is used for specifying a namespace in order to simplify description, and configures a part of the namespace declaration together with the URI. In other words, one namespace declaration is composed of a URI and a prefix associated with the URI. The problem is that duplication with the prefix may occur, meaning that a plurality of namespace declarations exist with respect to the same prefix.

Conventionally, this problem has been treated as a design or operational issue, and it is necessary to set the prefix of the namespace declaration while considering it in advance so that no duplication occurs. A large amount of work cost is required to solve this problem.

### BRIEF SUMMARY OF THE INVENTION

Consequently, the present invention is directed to provide a content management apparatus, method, and program product capable of properly providing content directory service based on the content information described by utilizing XML namespaces.

According to an aspect of the present invention, there is provided a content information management apparatus for transmitting first and second queries to first and second content providing devices which provide content information described in extensible mark up language by specifying a namespace, linking first content information provided from the first content providing device having responded to the first query with second content information provided from the second content providing device having responded to the second query thereby to generate a response having a tree structure, and transmitting the response according to a query from another device. The content information management apparatus comprises: an extractor configured to extract a first namespace declaration description from the first content information and a second namespace declaration description from the second content information; a detector configured to detect an occurrence of duplication between a first prefix included in the first namespace declaration description and a second prefix included in the second namespace declaration description when both of the which are placed on a most significant node of the tree structure; a processor configured to process the first and second content information in order to avoid the duplication; and a response generator configured to generate the response by linking the processed first and second content information.

### BRIEF DESCRIPTION OF THE SEVERAL VIEWS OF THE DRAWING

FIG. 1 is a view showing a configuration of a network system according to embodiments of the present invention;

FIG. 2 is a view showing an example of content information returned from a content information management apparatus when a control device has made a search request for content;

FIG. 3 is a view showing a DOM expression (partially omitted) of the content information in FIG. 2;

FIG. 4 is a view showing an example of a namespace declaration;

FIG. 5 is a view showing an example of a tree structure of content information;

FIG. 6 is a block diagram depicting a detailed configuration of the content information management apparatus;

FIG. 7 is a view showing procedures for updating a device-by-device namespace list when the content information management device has found out a peripheral device;

FIG. 8 is a view showing procedures for updating a device-by-device namespace list when a device has disappeared from a communication channel;

FIG. 9 is an activity diagram between the control device or content management apparatus and an AV device in the network system;

FIG. 10 is a view showing an example of content information which the AV device returns to the content information management apparatus;

FIG. 11 is a view showing a DOM expression of the content information in FIG. 10;

FIG. 12 is a view showing an example of content information which another AV device returns to the content information management apparatus;

FIG. 13 is a view showing a DOM expression of the content information in FIG. 12;

FIG. 14 is an activity diagram of a content information management apparatus according to a first embodiment of the present invention;

FIG. 15 is a view showing a DOM expression of a processing result relevant to a response from an AV device;

FIG. 16 is a view showing a DOM expression of a processing result relevant to a response from another AV device;

FIG. 17 is a view showing a link result of content information as a response to a controller device;

FIG. 18 is a view showing an XML description of the link result in FIG. 17;

FIG. 19 is an activity diagram of a content information management apparatus according to a second embodiment of the present invention;

FIG. 20 is a view showing a DOM expression of a processing result relevant to a response from an AV device;

FIG. 21 is a view showing a DOM expression of a processing result relevant to a response from another AV device;

FIG. 22 is a view showing a link result of content information as a response to a controller device;

FIG. 23 is a view showing an XML description of the link result in FIG. 22;

FIG. 24 is an activity diagram view showing activity of a content information management apparatus according to a third embodiment of the present invention;

FIG. 25 is a view showing an example of a device-by-device namespace list;

FIG. 26 is a view showing an example of a replacement namespace list.

FIG. 27 is a view showing a DOM expression of a processing result relevant to a response from an AV device;

FIG. 28 is a view showing a DOM expression of a processing result relevant to a response from another AV device;

FIG. 29 is a view showing a DOM expression of a link result of content information as a response to a controller device;

FIG. 30 is a view showing an XML description of a link result of content information as a response to the controller device;

FIG. 31 is a sequence diagram showing procedures for acquiring a namespace declaration according to a modified example of the third embodiment;

FIG. 32 is a view showing an example of a procedure calling of SOAP according to a fourth embodiment of the present invention;

FIG. 33 is a view showing an example of a Search operation;

FIG. 34 is a view showing the Search operation after edit processing;

FIG. 35 is a view showing an example of a CreateObject operation; and

FIG. 36 is an example showing an example of the CreateObject operation.

### DETAILED DESCRIPTION OF THE INVENTION

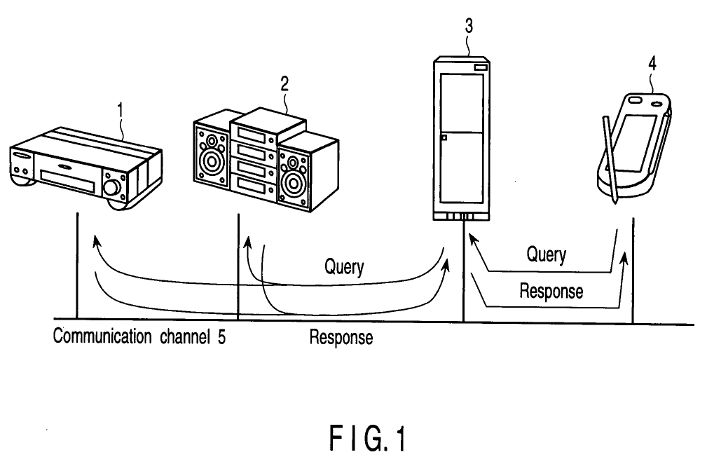

Embodiments of the present invention will be described with reference to the accompanying drawings. FIG. 1 is a view showing a configuration of a network system according to embodiments of the present invention. In this system, an AV device 1 having content and content information; an AV device 2; a content information management apparatus 3 in which the present invention is embodied; and a control device 4 which makes a request for the content information management apparatus 3 are connected to each other via a communication channel 5. The control device 4 makes a search request (browsing or searching content information) or an operating request (for example, generating, deleting, or changing content information) for the content information management apparatus 3. In response to these requests, the content information management apparatus 3 provides content directory service based on content information described by utilizing XML namespaces. The content information management apparatus 3 makes a search for the content information managed by itself and the AV device 1 and AV device 2 targeted for search, and generates a response to the control device 4 based on the search result. In addition, when the pieces of content information acquired from one's own device, the AV device 1, and the AV device 2 are collected to constrict a content information tree, the content information management apparatus 3 avoids collision of prefixes in a namespace declaration.

It is assumed that communication between the control device 4 and the content information management apparatus 3 is made in accordance with the UPnP A/V. The above-described content directory service is utilized as service defined under the UPnP A/V. It is also assumed that communication between the content information management apparatus 3 and the AV device 1 or the AV device 2 as well is made in accordance with the UPnP A/V in description of the embodiments. Although the control device 4 can request content information directly from the AV device 1 and the AV device 2 in accordance with the UPnP A/V without the interposed content information management apparatus 3, this does not relate to the present invention described below.

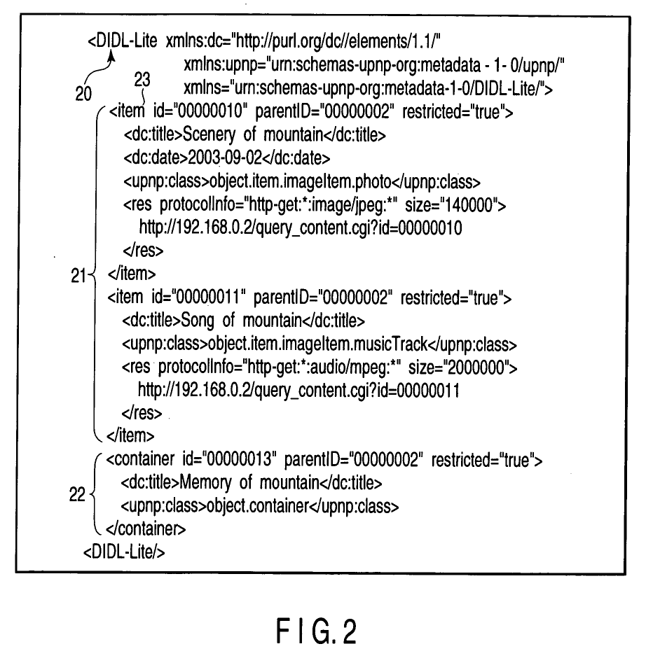

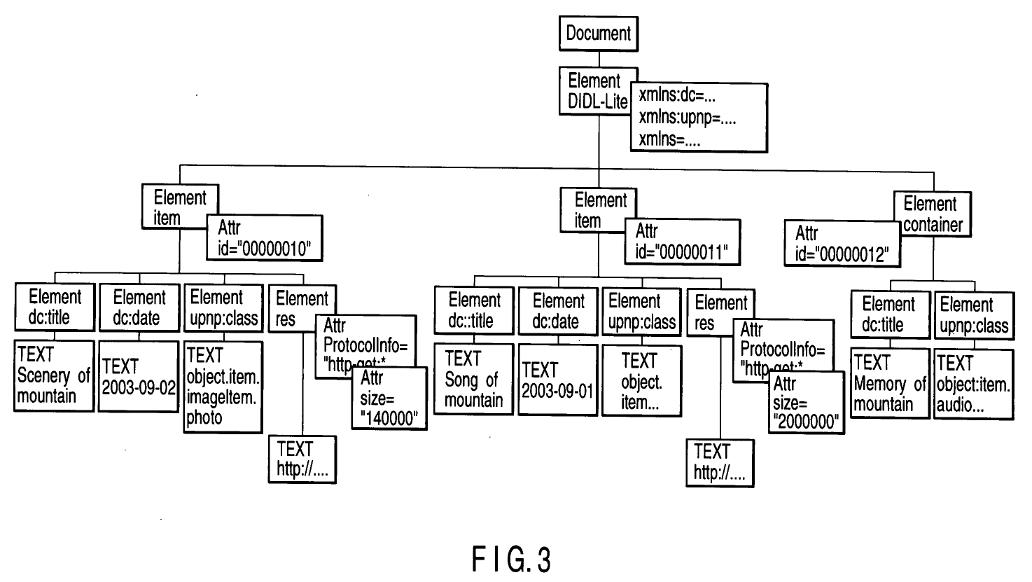

FIG. 2 shows an example of content information returned from the content information management apparatus 3 when the control device 4 has made a content search request. The content information is described in XML and two items 21 enclosed by the most significant <DIDL-Lite> tag 20 and one container 22 are described. For example, referring to content enclosed by a first <item> tag 23, “id” of this item is “00000011”, and its parent “id” is “00000002”. The title is “Scenery of Mountain”, and the date is 2003/09/02. An object class is “object.item.imageItem.photo”, and an actual medium resource is “http://192.168.0.2/query_content.cgi?id=00000010”, which can be accessed through HTTP. The data format is a JPEG image format, and the size is 140000. FIG. 3 shows a DOM expression (partially omitted) of this content information.

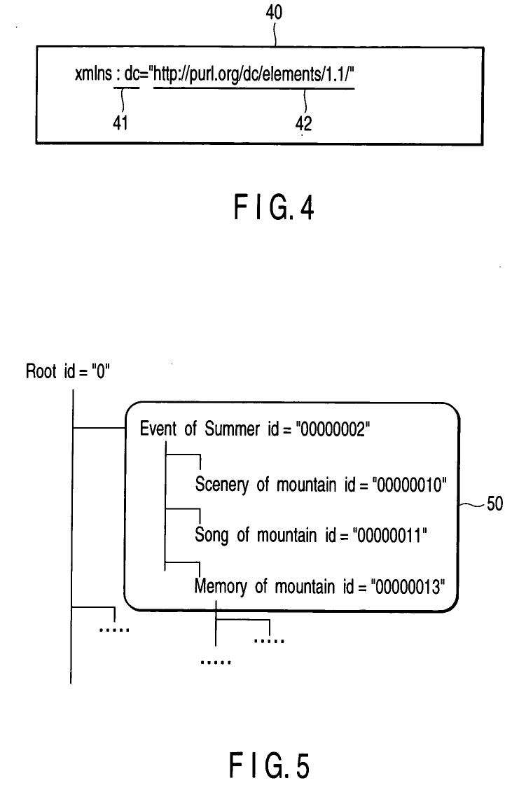

Referring to FIG. 4, an example of a namespace declaration is shown. A namespace declaration 40 includes “xmlns” indicating a namespace; a namespace prefix 41 (“dc” in this example) that follows the indicator; and a namespace URI 42 on right side of equality (“http://purl.org/dc/elements/1.1/” in this example). The prefix 41 is used for concisely specifying a namespace. The URI 42 and prefix 41 are associated with each other by means of equality.

In a tree of a DOM expression, if a prefix is assigned by each element name which belongs to a lower level than an element to which a namespace prefix has been assigned, an element name is defined in a namespace identified by the URI which corresponds to that prefix. That is, a range (scope) in which one namespace is effectively specified covers all the elements located at its lower level in a DOM expression. A namespace declaration is described like an attribute of the XML tag. A namespace declaration can be provided on a tag by tag basis. However, in the case of the UPnP A/V, such a namespace declaration is often provided collectively by the most significant tag. Here, the most significant tag corresponds to a <DIDL-Lite> tag.

FIG. 5 shows a part of a tree structure of a content information group that is managed by the content information management apparatus. The content information shown in FIG. 2 corresponds to a portion enclosed by a frame line 50.

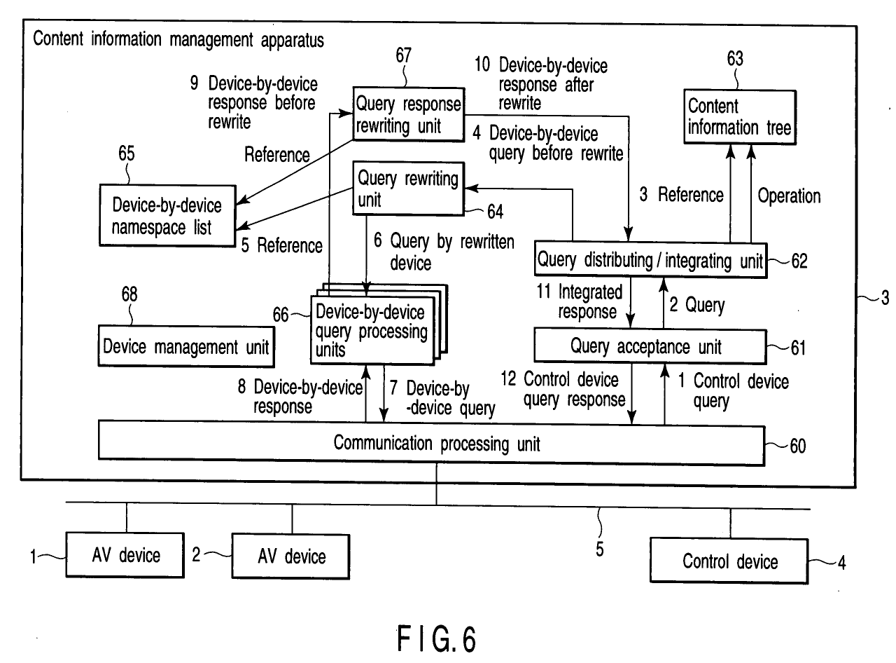

FIG. 6 is a block diagram depicting a detailed configuration of the content information management apparatus. As shown, the content information management apparatus 3 comprises: a communication processing unit 60; a query acceptance unit 61; a query distributing/integrating unit 62; a content information tree 63; a query rewriting unit 64; a device-by-device namespace list 65; and device-by-device query processing units 66. The query from the control device 4 which the communication processing unit 60 has received through the communication channel 5 is accepted by the query acceptance unit 61. The query acceptance unit 61 sends the accepted query to the distributing/integrating unit 62. The query distributing/integrating unit 62 provides the query to the content information tree 63 and also sends it to the query rewriting unit 64. The query rewriting unit 64 rewrites the sent query by referring to the device-by-device namespace list 65 and sends the rewritten query to corresponding one of the device-by-device query processing units 66. The corresponding one of the device-by-device query processing units 66 instructs the communication processing unit 60 to transmit this rewritten query to the corresponding device. In response to this instruction, the communication processor 60 transmits the query to the corresponding device (either of the AV devices 1 and 2 in this case) via the communication channel 5. The device makes a response to this transmission. This response is sent to the device-by-device query processing units 66 and is processed there. The device-by-device query processing units 66 send the device-by-device response to a query response rewriting unit 67. The query response rewriting unit 67 rewrites the device-by-device response by referring to the device-by-device namespace list 65 and sends this rewritten response to the query distributing/integrating unit 62. The query distributing/integrating unit 62 collects this rewritten response by linking it with the content information tree 63, and sends it to the query processing unit 61. The query processing unit 61 instructs the communication processing unit 60 so as to transmit this collected response to the control device 4. The communication processing unit 60 transmits the collected response to the corresponding control device 4 via the communication channel 5.

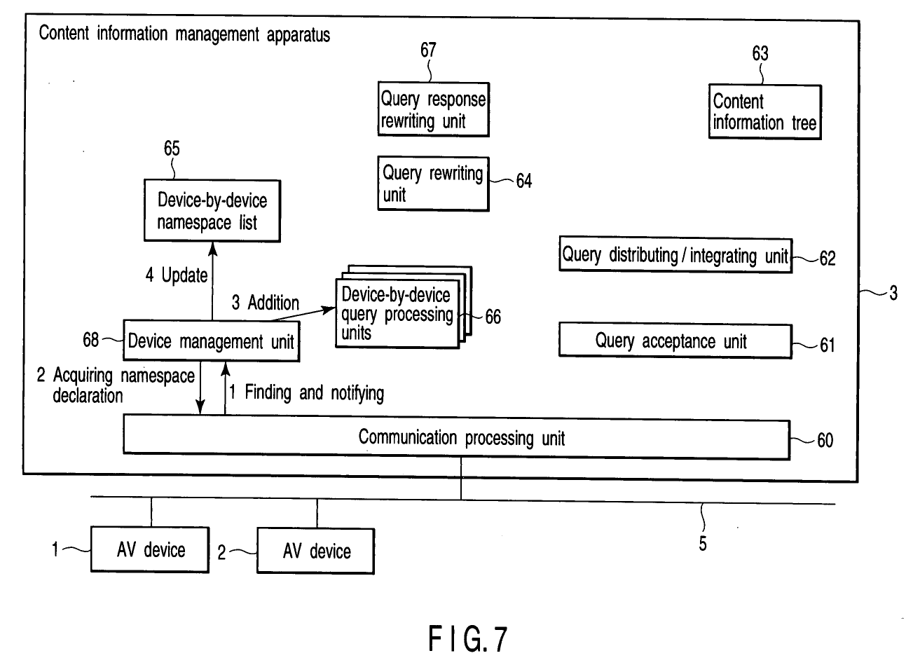

FIG. 7 is a view showing procedures for updating a device-by-device namespace list when the content information management apparatus has found out a peripheral device. When a device connected to the communication channel 5 (such as the AV devices 1 and 2) is found out, the communication processing unit 60 sends the notification of such finding to a device management unit 68. The device management unit 68 instructs the communication processing unit 60 so as to acquire a description of a namespace declaration from the found-out device. In addition, the device management unit 68 adds a query processing unit corresponding to the found out device to the device-by-device query processing units 66. The device management unit 68 also updates the device-by-device namespace list 65 based on the description of the namespace declaration.

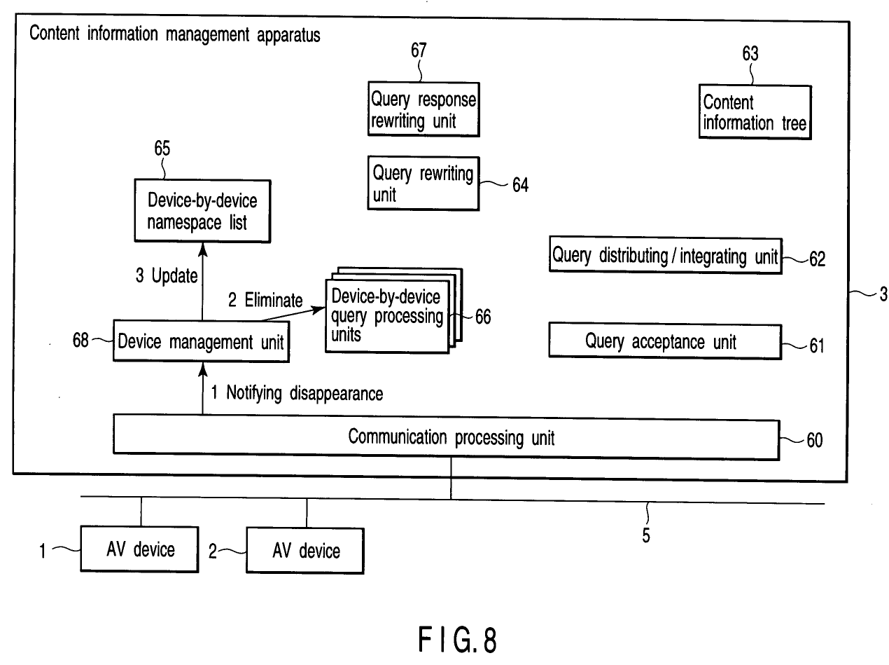

On the other hand, FIG. 8 shows procedures for updating a device-by-device namespace list when a device has disappeared from a communication channel. If the device disappears from the communication channel 5, the communication processing unit 60 detects this and sends the notification of such disappearance to the device management unit 68. The device management unit 68 deletes (invalidates) the corresponding one of the device-by-device query processing units 66 according to the notification of the disappearance and deletes an item of the device-by-device namespace list 65, thereby carrying out updating.

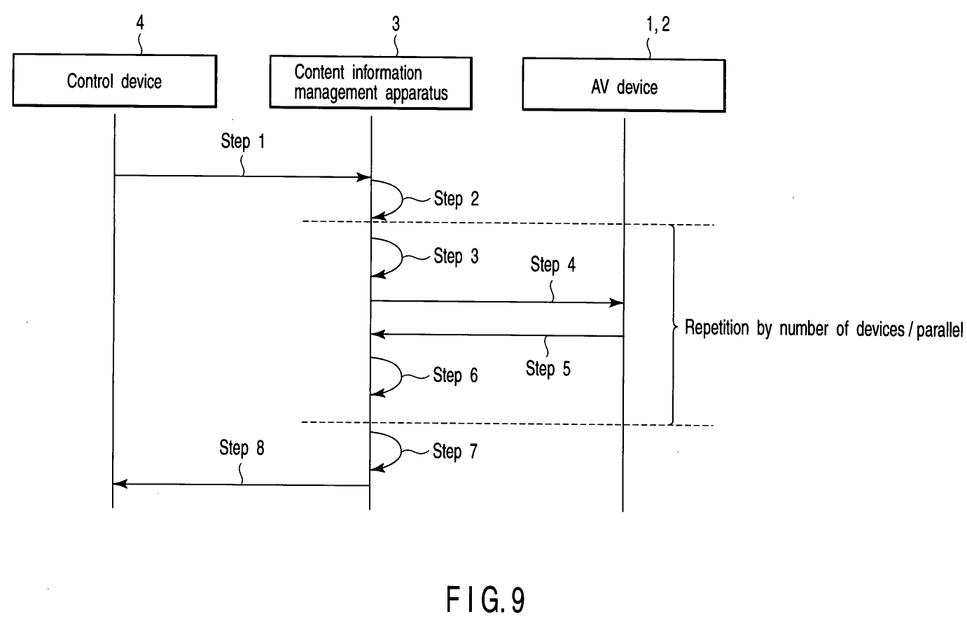

FIG. 9 is a view schematically showing activity between the control device or content information management apparatus and the AV device according to the present embodiment. This activity includes the following steps.

Step 1: The control device 4 sends a query to the content information management apparatus 3.

Step 2: The content information management apparatus 3 carries out preprocessing for the query.

Step 3: Based on the processing result of step 2, the content information management apparatus 3 selects a device (one's own device or AV device 1 or 2) which should correspond to the query, and carries out preprocessing for the device.

Step 4: Based on the processing result of step 3, the content information management apparatus 3 transfers the query to the device (one's own device or AV device 1 or 2) which corresponds to the query.

Step 5: The AV device 1 or 2 returns a response to the query from the content information management apparatus 3.

Step 6: The content information management apparatus 3 carries out post-processing for a response returned from each device.

Step 7: The content information management apparatus 3 links responses with each other in step 6, and carries out post-processing.

Step 8: The content information management apparatus 3 returns a response to the control device 4 based on the processing result in step 7.

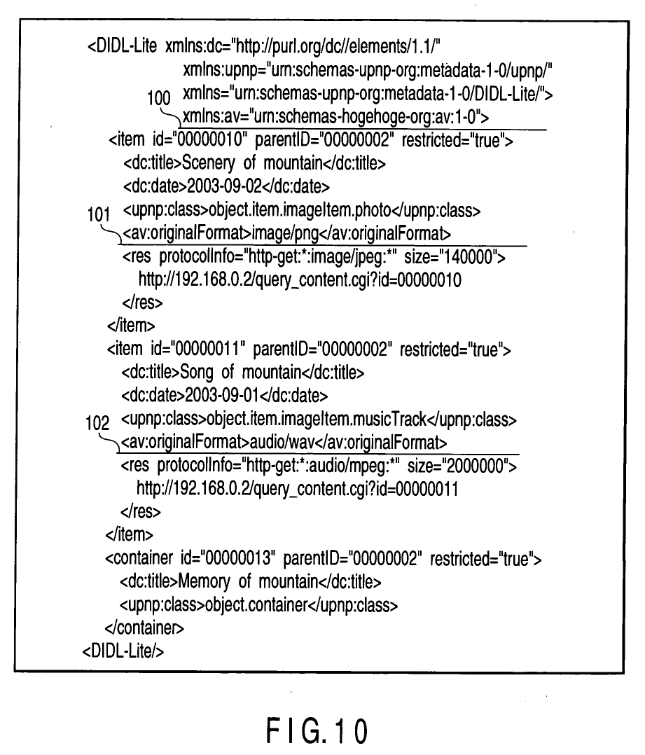

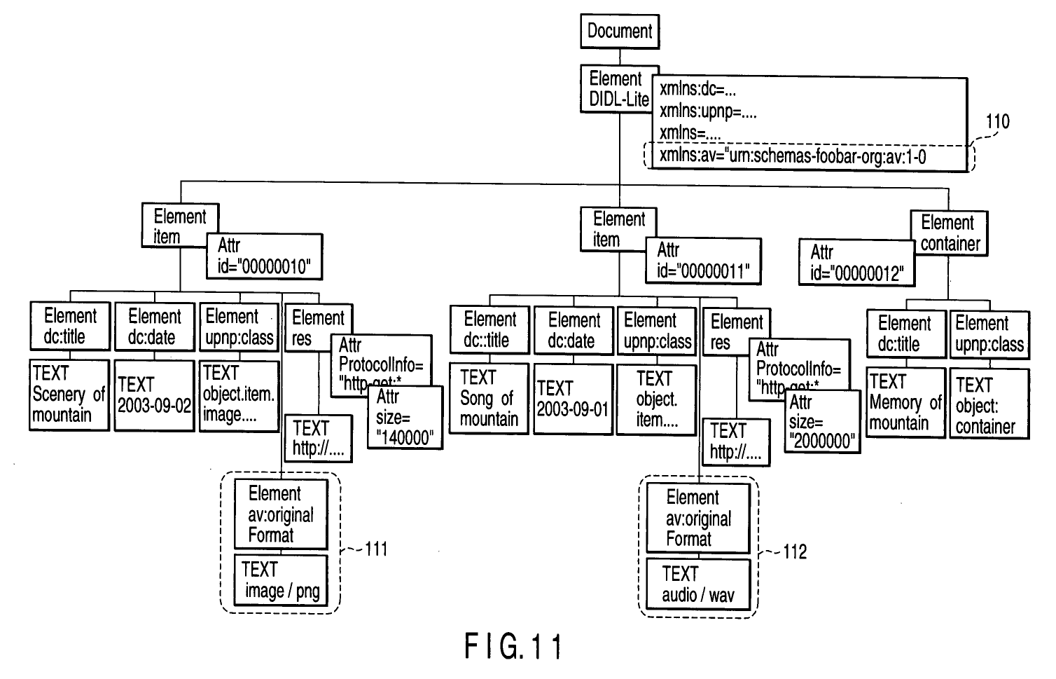

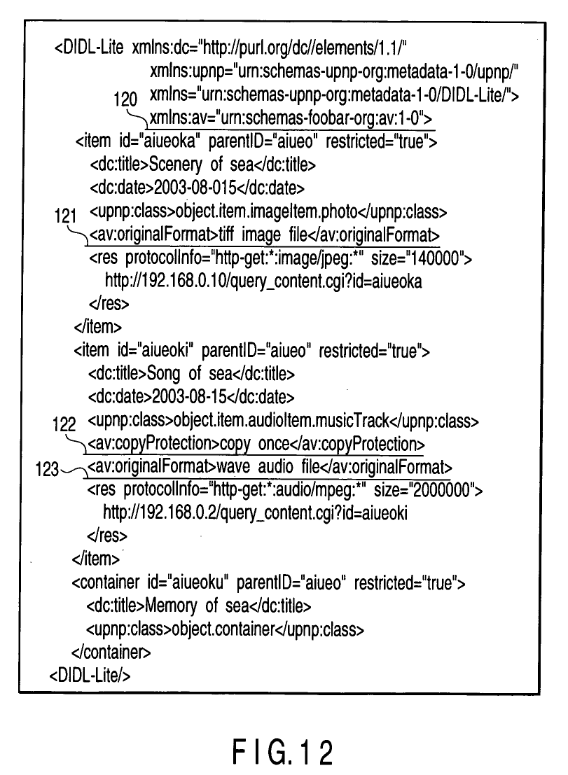

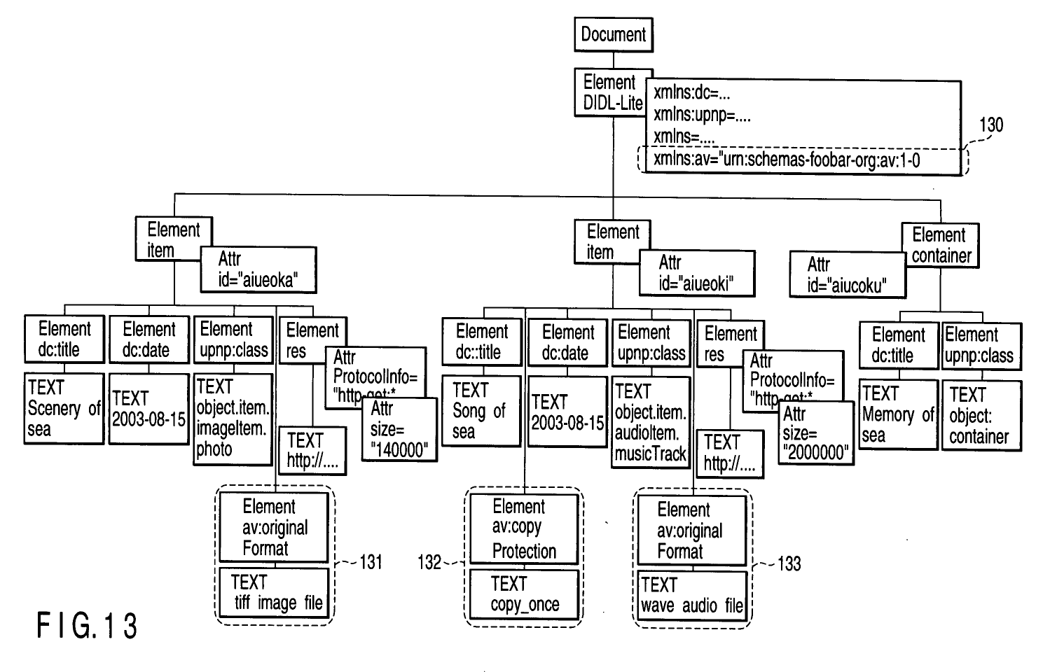

FIG. 10 shows an example of the content information which the AV device 1 returns to the content information management apparatus 3, and FIG. 11 shows an associated DOM expression. In the content information of FIG. 11, a namespace declaration 100 is a nonstandard, unique declaration in the UPnP A/V, and a prefix “av” is defined. This namespace declaration 110 is placed on and belongs to the most significant node in the DOM expression of FIG. 12 having a tree structure. In addition, in the content information of FIG. 11, a namespace is specified for each of elements 101, 102 by the prefix “av” defined in the namespace declaration 100. This declaration is a nonstandard, unique declaration in the UPnP A/V. These elements correspond to element nodes 111, 112 in FIG. 12. In FIG. 12, the namespace declaration 110 covers all the nodes from the most significant node to the least significant node. Similarly, FIG. 12 shows an example of the content information which another AV device 2 returns to the content information management apparatus 3, and FIG. 13 shows an associated DOM expression. In the content information of FIG. 12, a namespace declaration 120 is a nonstandard, unique declaration in the UPnP A/V, and a prefix “av” identical to that of the content information in FIG. 11 is defined. This namespace declaration 130 is placed on the most significant node in the DOM expression of FIG. 13. In addition, in the content information of FIG. 12, a namespace is specified for each of elements 121, 122 by the prefix “av” defined in the namespace declaration 120. This declaration is a nonstandard, unique declaration in the UPnP A/V. These elements correspond to element nodes 131, 132, 133 in FIG. 13. In FIG. 13, a namespace declaration 130 covers all the nodes from the most significant node to the least significant node.

When the above two pieces of content information are collected, the prefix “av” of a namespace is duplicated. The content information management apparatus 3 avoids such duplication in accordance with first to third embodiments described below. The first to third embodiments described below are applied to the above-described steps 5 to 8.

### First Embodiment

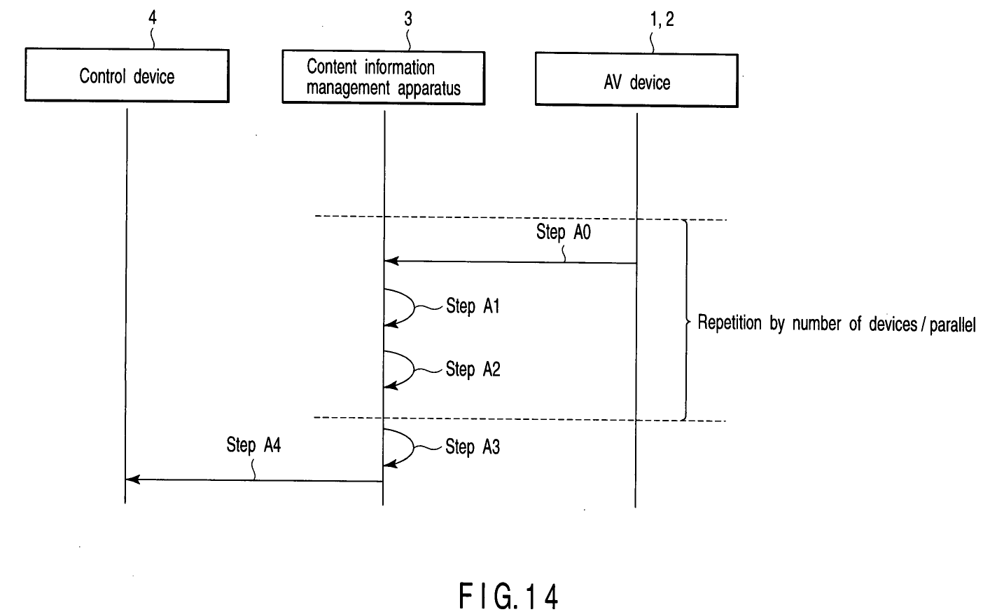

FIG. 14 is a view showing activity of a content information management apparatus according to a first embodiment of the present invention. This activity relates to a response generating method 1. The response generating method 1 reduces a scope (range) of a unique namespace. The activity is configured as follows.

Step A0: Receive a response from each of the AV devices 1 and 2.

Step A1: Extract each of the namespace declarations associated with a <DIDL-Lite> tag from the response received from each of the AV devices 1 and 2.

Step A2: Move a unique namespace declaration to a respective one which is lower than the <DIDL-Lite> tag by one level from among the extracted namespace declarations.

Step A3: Link responses with each other.

Step A4: Return the linked responses to the control device 4.

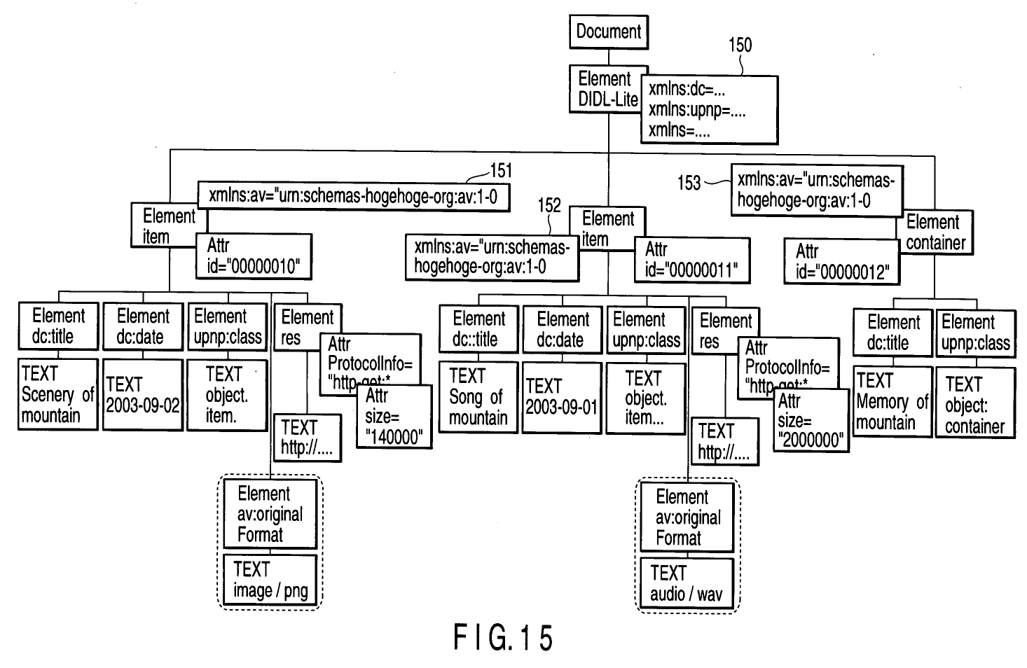

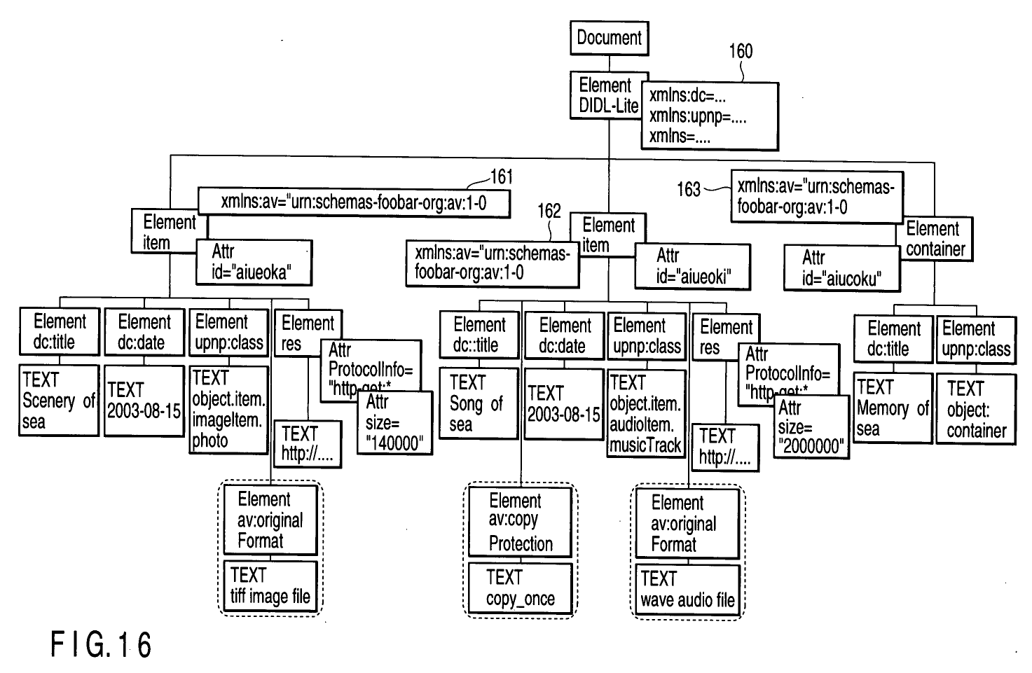

FIGS. 15 and 16 each show a processing result of a response from each of the AV devices 1 and 2 in accordance with step A2. As shown in the DOM expression of FIG. 15, a unique namespace declaration is not found out in a namespace declaration group 150 in the most significant <DIDL-Lite> node. In addition, unique namespace declarations 151, 152, 153 (all of them are identical) move to element node groups (three groups in this case) which are lower than the <DIDL-Lite> node by one level. In this manner, the range covered by a unique namespace declaration does not include the most significant <DIDL-Lite> node, and includes a range equal to or lower than an element node which is lower than the most significant node by one level. As shown in FIG. 16, with respect to this content information as well, a unique namespace declaration is not found out in a namespace declaration group 160 in the most significant <DIDL-Lite> node. In addition, unique namespace declarations 161, 162, 163 move to element nodes (three nodes in this case) which are lower than the <DIDL-Lite> node by one level. In this manner, the range covered by a unique namespace declaration does not include the most significant <DIDL-Lite> node, and includes a range equal to or lower than an element node which is lower than the most significant node by one level.

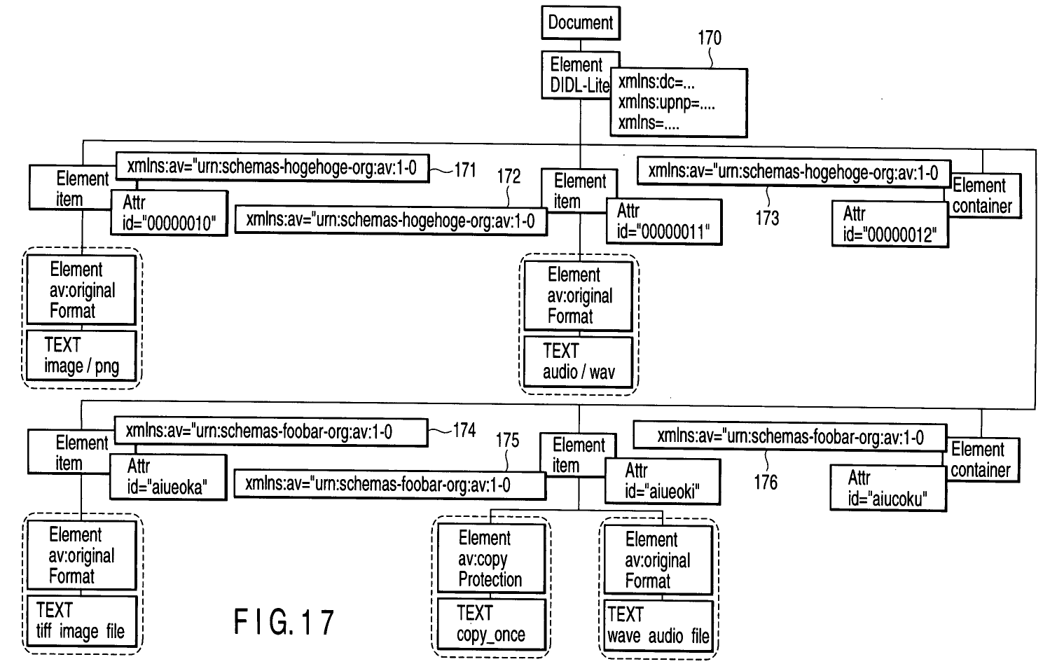

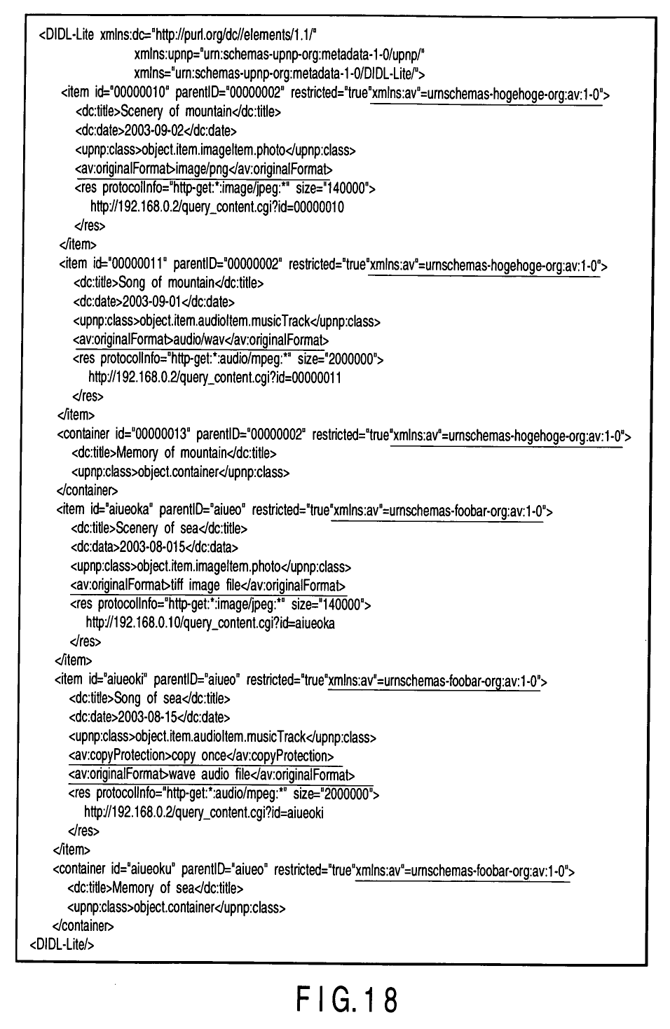

FIG. 17 shows a link result of these pieces of content information in accordance with step A3, and FIG. 18 shows an associated XML description. As shown in FIG. 17, after linking as well, a uniquely defined namespace declaration is not placed on the most significant node. Items of content information (six elements in this case).are linked with each other as element nodes which are lower than the most significant node by one level. Unique namespace declarations 171 to 173 correspond to namespace declarations 151 to 153 (FIG. 15) of a link source. Unique namespace declarations 174 to 176 correspond to namespace declarations 161 to 163 (FIG. 16) of a link source which are different from the unique declarations 171 to 173. The range covered by a namespace declaration includes a node which is lower than a node to which the namespace declaration belongs, and thus, a problem with duplication of prefixes can be avoided.

Note that an identifier of the content information indicated by id=“ . . . . ”, parent ID=“ . . . . ” is required to be unique when the identifier is delivered to the control device 4. In the following description, it is assumed that these content information identifiers are guaranteed to have been already unique. Actuality, the same identifier may be assigned between different devices (excluding “0” which is a root of a content tree of each device). In order to prevent such duplication, it is necessary to reassign the content information identifiers in the content information management apparatus 3. Specifically, for example, a UDN (Unique Device Name) whose uniqueness is guaranteed on a device-by-device basis may be prefixed to each content identifier. Alternatively, a tree structure of the content information according to a response may be individually provided from the content information management apparatus 3.

According to the first embodiment described above, a problem with duplication of prefixes can be avoided and a response can be generated by a response generating method for reducing a scope of a unique namespace. The response generating method 1 is advantageous in simple operating procedures, although a namespace declaration becomes a redundant description.

### Second Embodiment

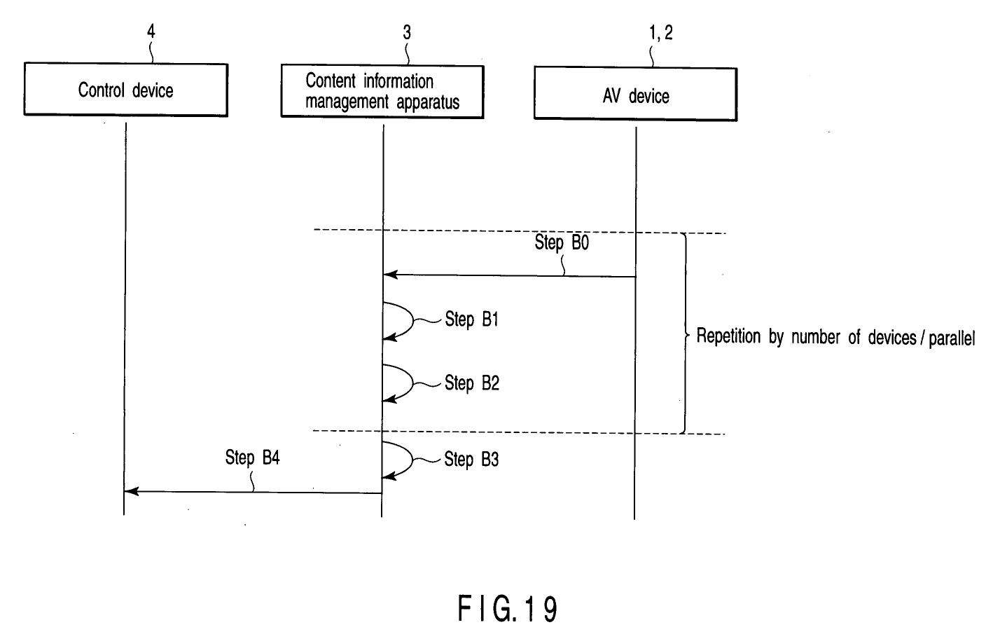

FIG. 19 is a view showing activity of a content information management apparatus according to a second embodiment of the present invention. This activity relates to a response generating method 2. The response generating method 2 eliminates all the information relating to a unique namespace declaration. The activity is configured as follows.

Step B0: Receive a response from each of the AV devices 1 and 2.

Step B1: Extract each namespace declaration associated with the most significant <DIDL-Lite> tag from the response from each of the AV devices 1 and 2.

Step B2: Eliminate a definition relating to a unique namespace declaration of the extracted namespace declarations, eliminate all the elements and attributes described together with specification of the unique namespace, and define the deletion as a response.

Step B3: Link responses with each other obtained in step B2.

Step B4: Return the linked response to the control device 4.

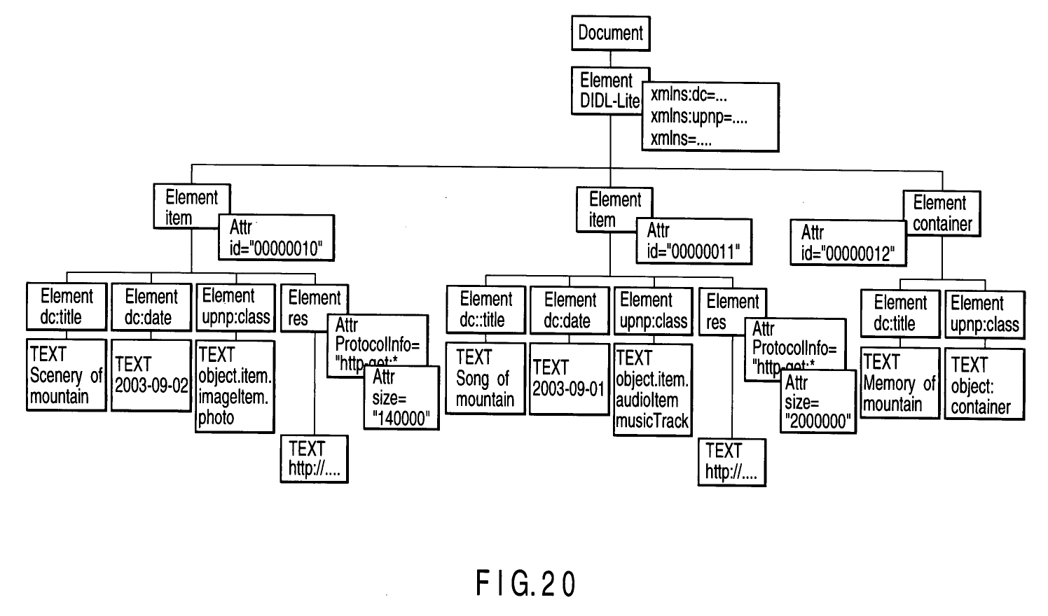

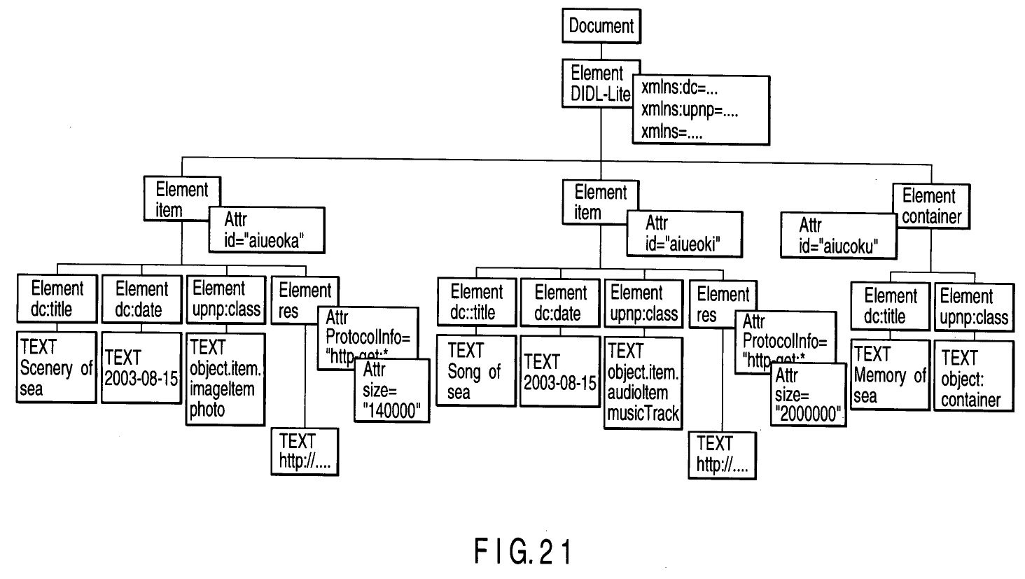

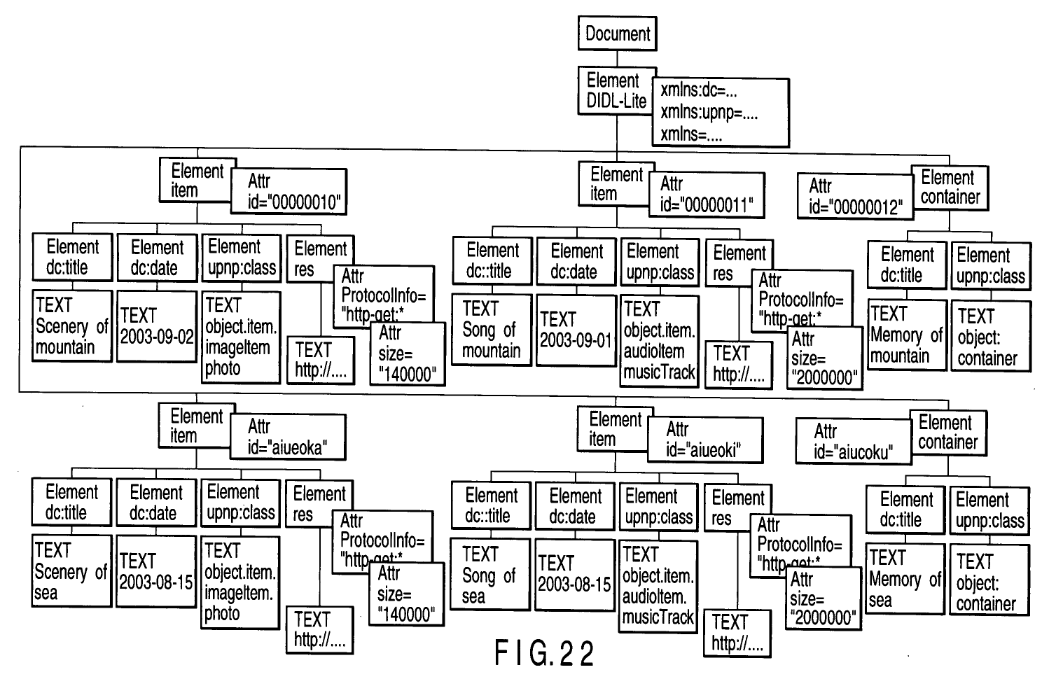

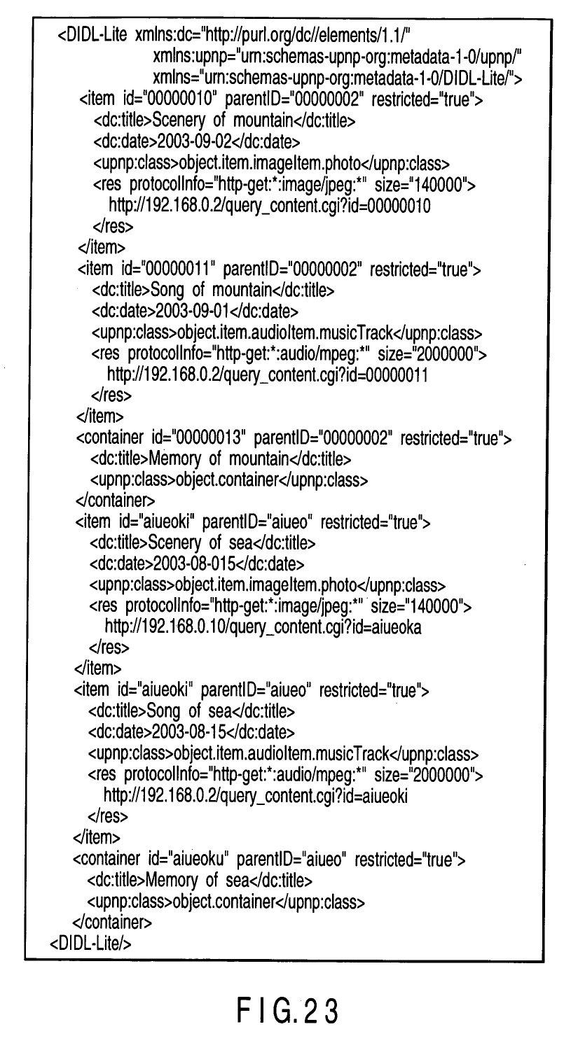

FIGS. 20 and 21 each show a processing result relevant to a response from each of the AV devices 1 and 2 in accordance with step B2. Further, FIG. 22 shows a link result in accordance with step B3, and FIG. 23 shows a final response to the control device 4 in accordance with step B4. As is evident from these figures, any description relating to a unique namespace is not included in content information. Inevitably, the prefixes (“av” in this case) of namespaces are not duplicated.

According to the second embodiment described above, a problem with duplication of prefixes can be avoided and a response can be generated by the response generating method 2 for deleting all the information relating to a unique namespace declaration. The response generating method 2 cannot provide content information based on a unique definition. However, there is attained an advantage that the present invention can be applied to the control device 4 which has only such a limited capability of supporting only a standard namespace.

### Third Embodiment

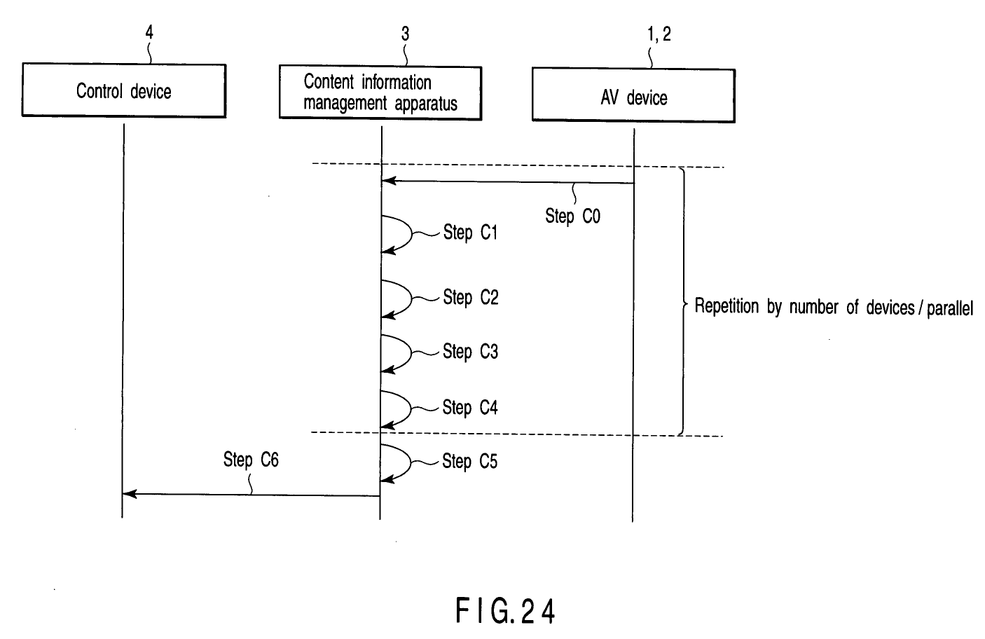

FIG. 24 is a view showing activity of a content information management apparatus according to a third embodiment of the present invention. This activity relates to a response generating method 3. The response generating method 3 manages a prefix of a unique namespace. Specifically, duplicated prefixes are replaced with other prefixes so that they are different from each other.

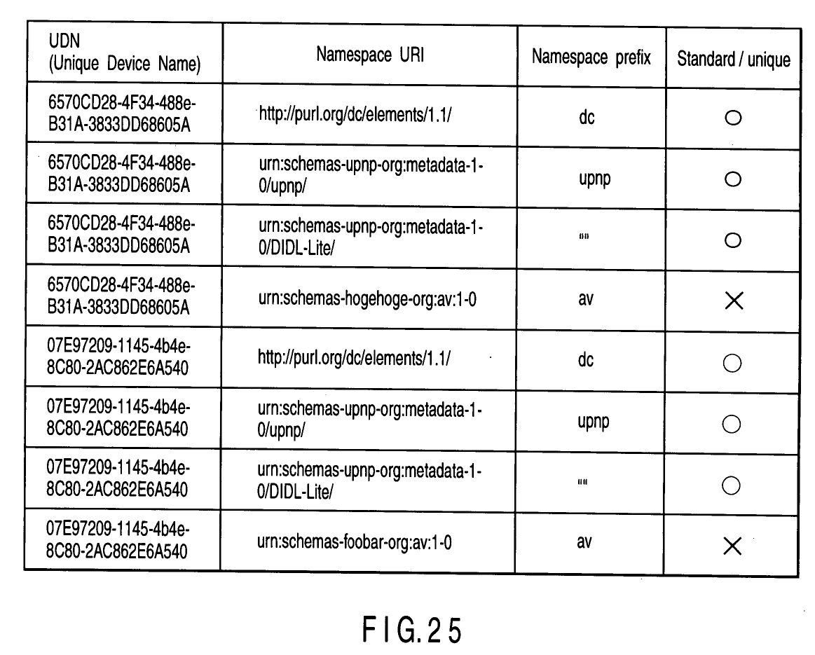

The content information management apparatus 3 has a device-by-device name list (refer to reference numeral 65 of FIG. 6) and a replacement namespace list. The device-by-device namespace list includes: a device identifier (UDN); a URI; a namespace prefix; and information for discriminating whether at least either of a prefix and URI of the namespace is a UPnP A/V standard one or a nonstandard unique one. The replacement namespace list has: a URI; a new namespace prefix after replaced; and information for discriminating whether the URI is a UPnP A/V standard one or a nonstandard unique one. FIG. 25 shows an example of a device-by-device namespace list, and FIG. 26 shows an example of a replacement namespace list.

As shown in FIG. 25, the device-by-device namespace list corresponds to namespace information extracted from a namespace declaration in which the top three lines are included in a response example from the AV device 1, and corresponds to namespace information extracted from a namespace declaration in which the bottom three lines are included in a response example from the AV device 2 (refer to the step C2 below). As shown in FIG. 26, in the replacement namespace list, with respect to URIs uniquely defined by the AV device 1 and the AV device 2, the URIs being duplicated in the device-by-device namespace list, a namespace prefix “av” is replaced with new prefixes “av1”, “av2”.

In the device-by-device namespace list, a namespace prefix of the same name may exist, but in the replacement namespace list, a namespace prefix is defined to be unique. A method for replacing a character string of a prefix with another character string to prevent duplication includes the following, for example:

(1) A character string of a namespace prefix is copied from a device-by-device namespace list; a character string is regularly added (for example, “1” is added at the end of the prefix) such that the namespace prefix is different from any other element of the replacement namespace list; and the added character string is defined as a new prefix.

(2) It is possible to carry out generation based on a unique parameter such as a time when a new space prefix after replaced is generated.

As shown in FIG. 24, the activity according to the present embodiment is configured as follows. Step C0: Receive responses from each of the AV devices 1 and 2.

Step C1: Extract a namespace declared by the most significant <DIDL-Lite> tag in a response returned by each of the AV devices 1 and 2.

Step C2: Add a pair of URI and prefix of the extracted namespace and a device identifier (here, a UDN (Unique Device Name) for use in device identification is used in the UPnP) to a device-by-device namespace list.

Step C3: Generate a new prefix for each URI of a device-by-device namespace list, and add the generated prefix to a replacement namespace list.

Step C4: Replace a namespace prefix which appears in each response with a new prefix which corrects to a replacement namespace list.

Step C5: Link responses with each other.

Step C6: Return the linked responses to the control device 4.

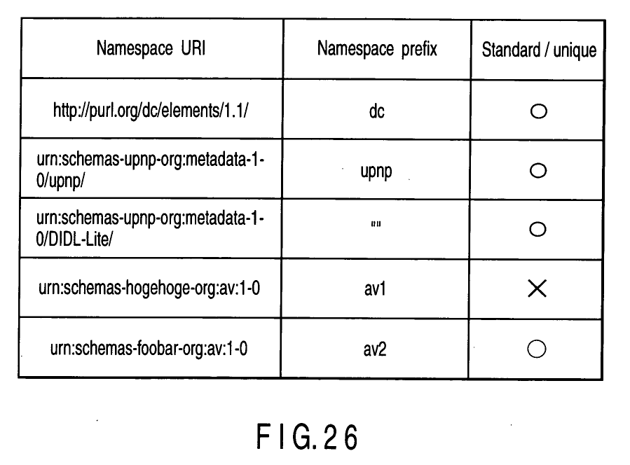

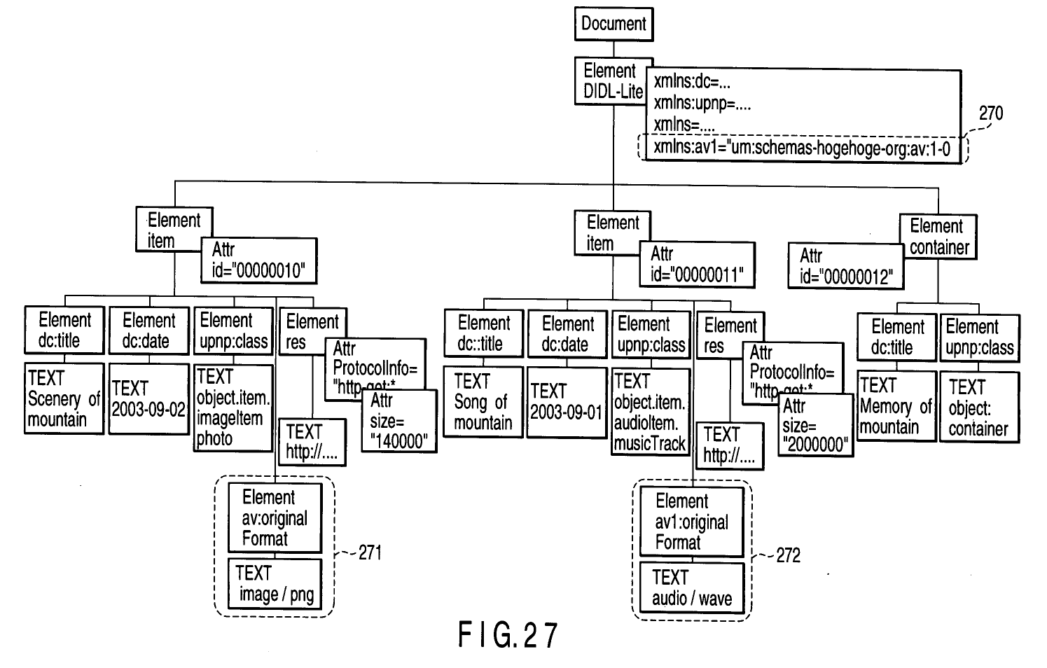

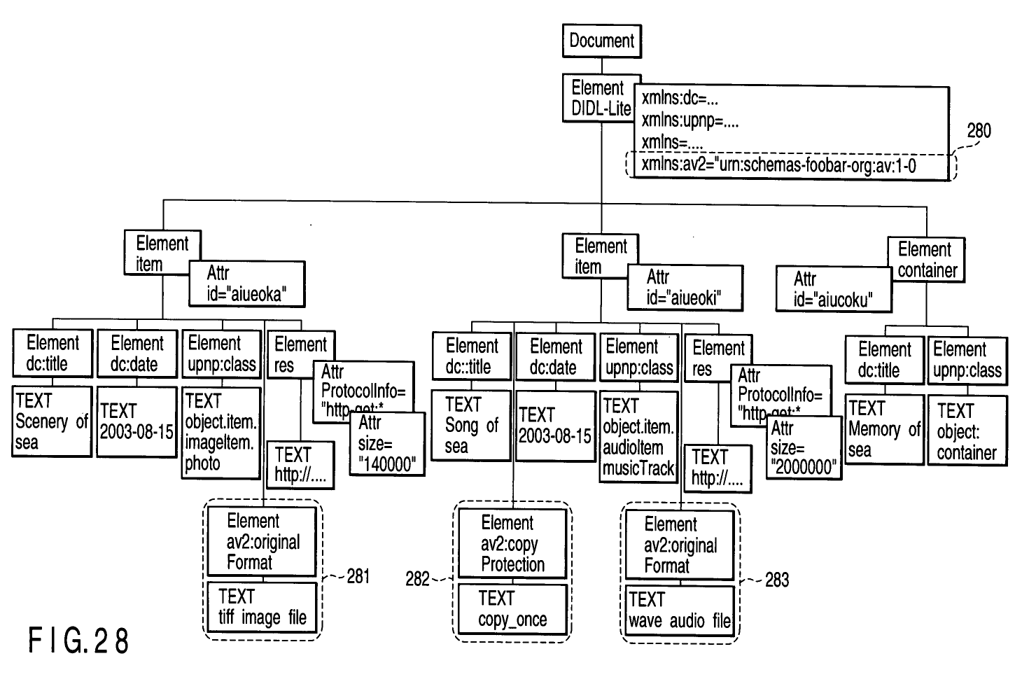

FIGS. 27 and 28 each show a processing result relevant to a response from each of the AV devices 1 and 2 in accordance with step C4. As shown in FIG. 27, in the content information on the processing result of the response from the AV device 1, although a prefix of a namespace declaration 270 in the most significant node has been “av”, this prefix is replaced with “av1” so as to be identified from the replacement namespace list of FIG. 26. Similarly, with respect to element nodes 271, 272 associated with namespace specification based on this namespace declaration 270 as well, the prefix is replaced with “av1”. As shown in FIG. 28, in the content information on a processing result of the response from the AV device 2, although a prefix of a namespace declaration 280 in the most significant node has been “av”, this prefix is replaced with “av2” so as to be identified from the replacement namespace list of FIG. 26. Similarly, with respect to element nodes 281 to 283 associated with namespace specification based on this namespace declaration 280 as well, the prefix is replaced with “av2”.

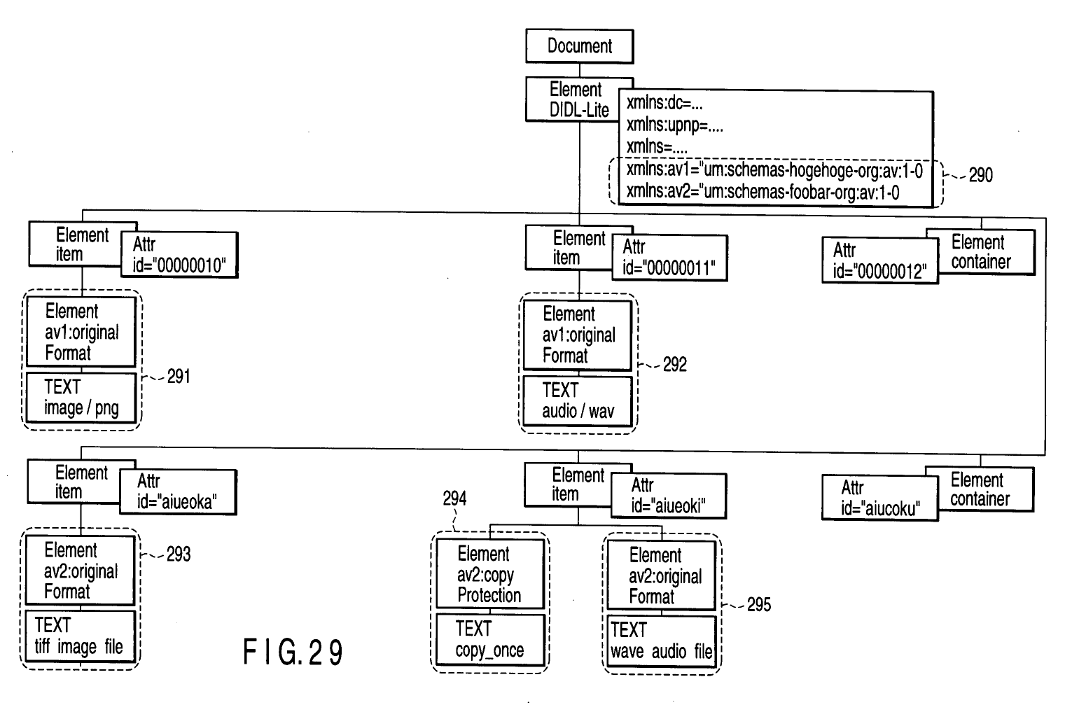

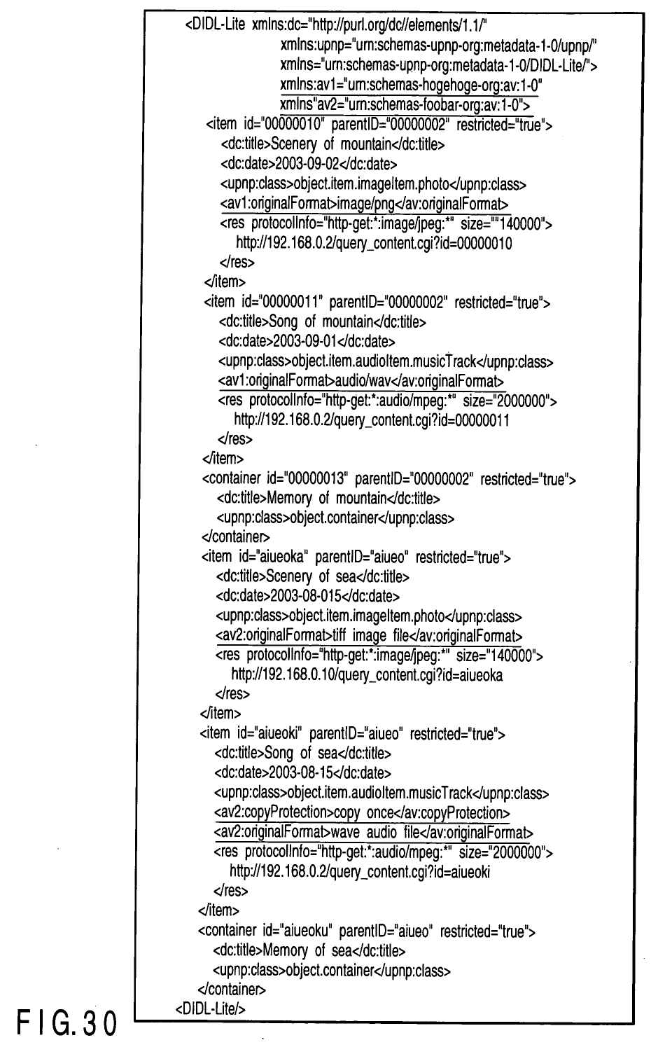

FIG. 29 shows a link result in accordance with step C5, and FIG. 30 shows a final response to the control device 4 in accordance with step C6. As shown in FIG. 29, in the link result of content information, two unique namespace declarations 290 at a namespace declaration portion of the most significant node, a prefix is not duplicated with another one. Further, in element nodes 291 and 292, “av1” which is different from a prefix “av2” in other element nodes 293 to 295 is used for specifying a namespace.

According to the third embodiment described above, although there is a need for cost for managing the above two namespace lists and replacement processing cost in the step C4, all the namespace declarations cannot be included in the most significant node <DIDL-Lite> of a response to the control device 4. Thus, processing relating to a namespace of a response received in the control device 4 can be simplified.

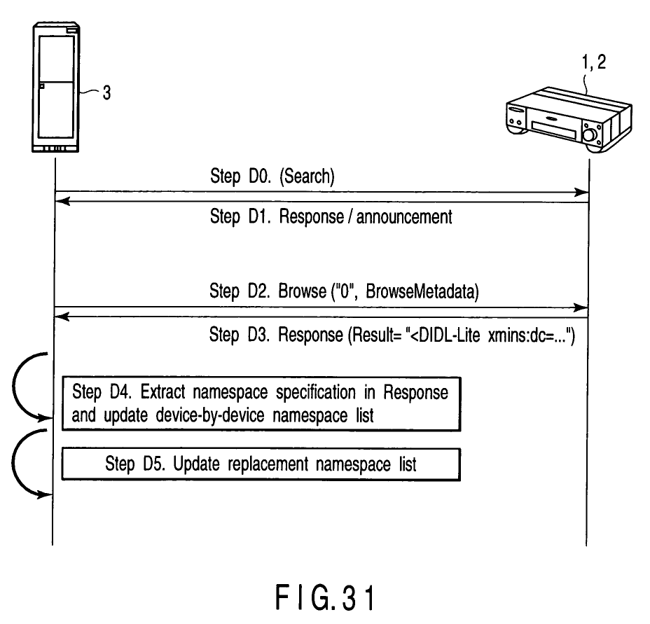

The activity of FIG. 24 can be modified as that which produces a device-by-device namespace list only once immediately after each of the AV devices has been found out. In this manner, processing cost relating to management of a device-by-device namespace list and a replacement namespace list can be reduced. However, it is presumed that a namespace declaration in each of the AV devices (content management apparatus) is unchanged. FIG. 31 is a view showing activity according to this modified example.

Step D0: The content information management apparatus 3 attempts to find out a peripheral device. Here, a “discover” message of a SSDP (Simple Service Discovery Protocol) of UPnP is sent onto the communication channel 5.

Step D1: The AV device 1 or 2 sends an SSDP response to the content information management device 3 and shows the presence of one's own device. Alternatively, the AV device 1 or 2 sends an alive (arrival) message of the SSDP, thereby announcing the presence of one's own device to a peripheral device regardless of the presence or absence of the “discover” message in step 0. These processes are included in normal operating procedures for the UPnP device.

Step D2: The content information management apparatus 3 sends a browse action (Browse (“0” BrowseMetadata)) to the AV device 1 or 2 which has been newly found out. This browse action corresponds to query of acquiring content information on a route element “0” which always exists, from among the content tree possessed by the AV device 1 or 2.

Step D3: The AV device 1 or 2 returns a response to a browse action. A namespace declaration associated with the <DIDL-Lite> tag is included in this response.

Step D4: A namespace declaration is extracted from the above response, and information indicating whether or not the extracted namespace declaration is a device identifier, a URI, a namespace prefix, and a standard namespace of the AV device 1 or 2 is added to a device-by-device namespace list, thereby carrying out updating.

Step D5: Updates a part of a replacement namespace list which corresponds to an update portion of the device-by-device namespace list.

### Fourth Embodiment

In a fourth embodiment of the present invention, a detailed description will be given with respect to operating procedures for the content information management apparatus 3 to accept query from the control device 4 and the subsequent processes. These operating procedures correspond to steps 1 to 4 described in the first embodiment, and are specifically as follows.

Step E0: The control device 4 sends query to the content information management apparatus 3.

Step E1: The content information management apparatus 3 determines whether the accepted query corresponds to a search request or an operating request.

Step E2: The content information management apparatus 3 selects the corresponding one's own device or AV device 1 or 2 from the content information identifiers defined as a start point of search or targeted for operation with respect to the accepted query.

Step E3: The content information management apparatus 3 carries out any conversion described later based on the namespace declaration of the corresponding one's own device or AV device 1 or 2 with respect to the accepted query.

Step E4: The converted query is sent to the corresponding one's own device or AV device 1 or 2.

In response to query made from the control device 4 to the content management apparatus 3 in step E0, the content management apparatus 3 carries out acceptance processing in accordance with any of the acceptance methods described below for each of the response generation methods described in the above-described first to third embodiments.

(Case of Response Generating Method 1)

Acceptance method 1: Reject acceptance of query which includes an element and an attribute associated with specifying a unique namespace.

Acceptance method 2: Carry out processing for query so as to prefix a complete URI without using a prefix for specifying an element and an attribute associated with specifying a unique namespace. For example, “av1:originalFileFormat” is defined as “urn:schemas-hogehoge-org:av:1-0:originalFileFormat”.

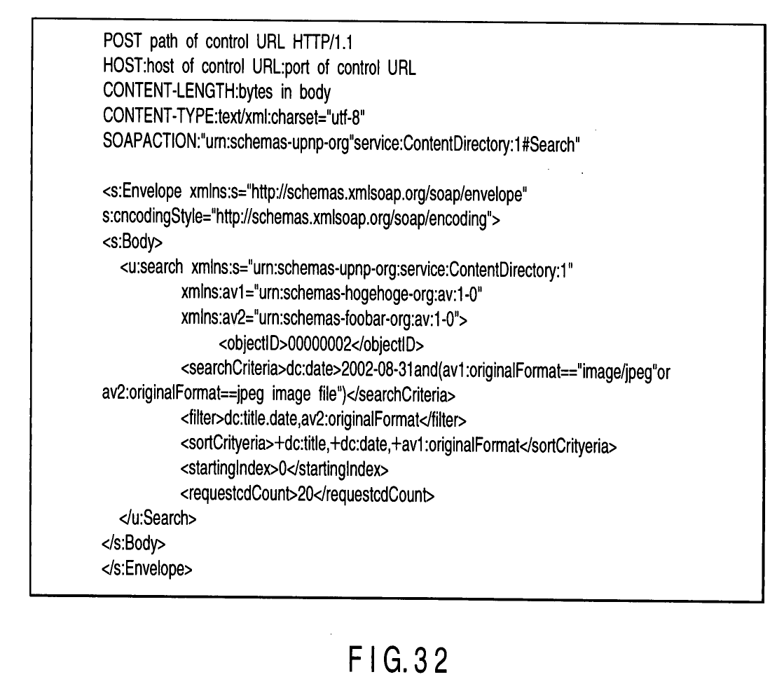

Acceptance method 3: Assign a namespace declaration to an argument tag of SOAP (Simple Object Access Protocol). A procedure call such as UPnP query is made by SOAP. In SOAP, a procedure name and its argument are described in XML. A proper namespace declaration is added to an argument tag or a procedure name tag positioned to be higher than the argument tag by one level, and an element name or an attribute name whose prefix was prefixed is used. FIG. 32 shows an example of a procedure call of SOAP. In this example, namespace declarations “av1”, “av2” are added to a <Search> tag which is a procedure name tag.

(Case of Response Generating Method 2)

Acceptance method 4: Reject acceptance of query which includes an element and an attribute associated with specification of a unique namespace.

(Case of Response Generating Method 3)

Any of acceptance methods 1 to 3 is used in the same manner as in response generating method 1. Alternatively, as acceptance method 5, processing may be carried out for query so as to prefix a namespace prefix defined in a replacement namespace list.

Here, the above step E3 will be described in more detail. A query is roughly divided into two requests, i.e., a search request and an operating request. The processing methods are different depending on types of these queries, as described below.

(1: Case in Which Query is a Search Request)

With respect to a search request, in the UPnP A/V, two operations, i.e., a Browse operation and a Search operation are defined. For example, in the Search operation, a content information identifier defined as a start point of search, a search condition and a filter condition, a sort condition, and a specified number of cases are assigned as arguments. Here, an element associated with a namespace prefix can be used for describing the search condition and filter condition or the sort condition.

(Processing Method 1: Returning an Error Response)

Step E3-1: Check whether or not the request includes a namespace specification and its element or attribute which are not compatible with the AV in the search condition, filter condition, and sort condition.

Step E3-2: In the case where a request includes a namespace specification and its element or attribute which are not compatible with the AV device, this step returns an error response to the request.

(Processing Method 2: Returning a Null Response)

Step E3-1: Check whether or not the request includes a namespace specification and its element or attribute which are not compatible with the AV in the search condition, filter condition, and sort condition.

Step E3-2: In the case where a request includes a namespace specification or its element or attribute which are not compatible with the AV device in the above step, this step returns a null response indicating that content information corresponding to the request does not exist.

(Processing Method 3: Eliminating an Incompatible Namespace Element and an Attribute)

Step E3-1: Check whether or not the request includes a namespace specification and its element or attribute which are not compatible with the AV in the search condition, filter condition, and sort condition.

Step E3-2: In the case where the request includes a namespace specification and its element or attribute which are not compatible with the AV device in the above step, this step carries out the following steps.

Step E3-2a: Eliminate a specification relating to an element of a namespace which is not compatible with the AV device from the sort condition.

Step E3-2b: Eliminate a specification relating to an element of a namespace which is not compatible with the AV device from the filter condition.

Step E3-2c: Replace an item relating to an element of a namespace which is not compatible with the AV device to a FALSE value from the search condition.

Step E3-3: Acquire a prefix of a namespace compatible with the AV device from a device-by-device namespace list, and replace a current prefix with the acquired prefix.

Step E3-4: Sends the above processing result as a query to the AV device.

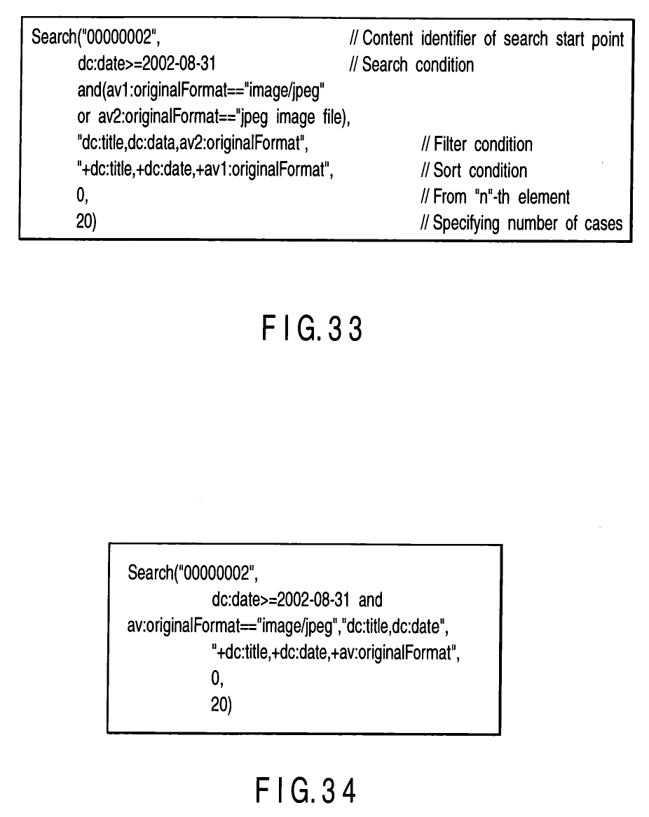

For example, three processing examples relevant to the Search operation shown in FIG. 33 are presented below. Here, it is presumed that the query from the control device 4 is processed in accordance with acceptance method 5, and response generating method 3 is used.

(Processing Method 1: Returning an Error Response)

Returns an error response for a reason why a namespace element (“av2:originalFormat”) which is incompatible with the AV device 1 is used.

(Processing Method 2: Returning a Null Response)

Returns a null response for a reason why a namespace element (“av2:originaFormat”) which is not compatible with the AV device 1 is used.

(Processing Method 3: Editing and Sending a Search Operation)

A Search operation after an editing process as shown in FIG. 34 is sent to the AV device 1. In this editing process, an element associated with “av2” is eliminated, and the prefix “av1” is replaced with “av”.

According to the above processing methods 1 and 2, a simple responding process suffices, and a processing burden is not required. In contrast, in the case of the processing method 3, a possibility that a request fails according to the content information to be assigned to an argument can be reduced to the minimum. In addition, it is preferable that this method can be compatible with an AV device which is insufficient in processing capability relevant to a namespace by replacing a namespace specification with a prefix which is compatible with an AV device of a query destination. In order to restrict an affect caused by missing of a part (element) of content information, an error response may be returned when an incompatible namespace element is included in an argument.

(2: Case in Which a Query is an Operating Request)

With respect to an operating request, four types of operations are defined as “CreateObject”, DestroyObject”, “UpdateObject”, and “CreateReference” in the UPnP A/V. For example, in CreateObject, a content information identifier defined as a start point of creation and a description starting with <DIDL-Lite> of the content information created immediately beneath the identifier are assigned as arguments. An element associated with a namespace prefix is used for a content information description created here.

(Processing Method 1: Returning an Error Response)

Step E3-1: Check whether or not a content information description argument includes a namespace specification and its element or attribute which are not compatible with the AV device.

Step E3-2: In the case where the content information description argument includes a namespace specification and its element or attribute which are not compatible with the AV device, this step returns an error response to the request.

(Processing Method 2: Carrying out Actual Processing After Eliminating an Incompatible Namespace Element and an Attribute)

Step E3-1: Check whether or not a content information description argument includes a namespace specification and its element or attribute which are not compatible with the AV device.

Step E3-2: In the case where the content information description argument includes a namespace specification and its element or attribute which are not compatible with the AV device in the above step, this step eliminates the element or attribute.

Step E3-3: Acquire a prefix of a namespace compatible with the AV device from a device-by-device namespace list, and replaces a current prefix with the acquired prefix.

Step E3-4: Send the above processing result as a query to the AV device.

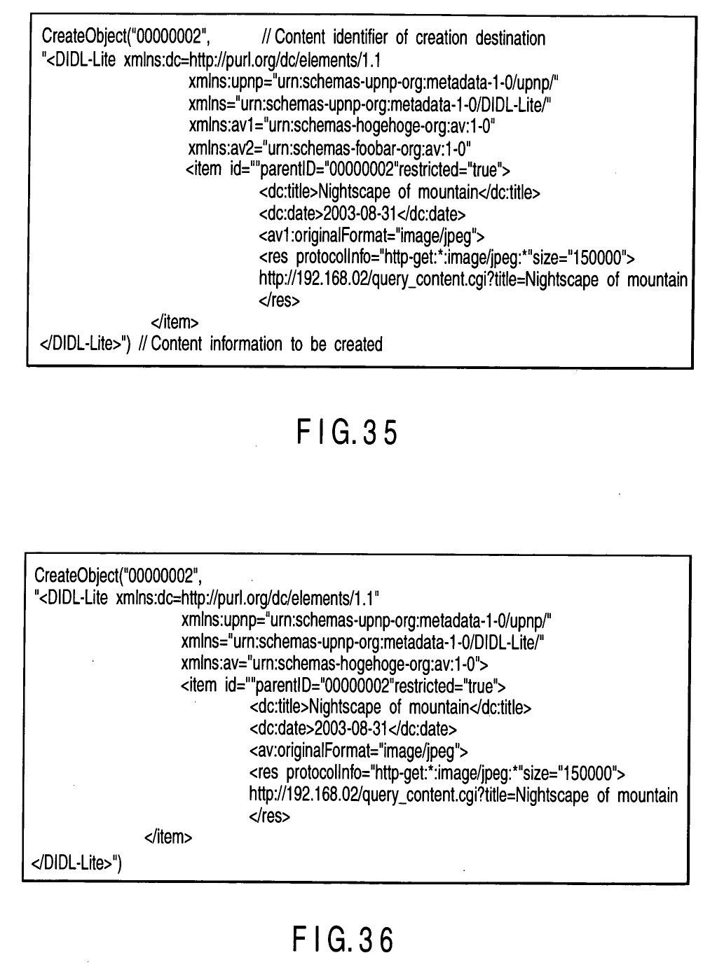

For example, two processing examples relevant to the CreateObject operation shown in FIG. 35 are presented below. Here, it is presumed that a query from the control device 4 is processed in accordance with acceptance method 5, and response generating method 3 is used.

(Processing Method 1: Returning an Error Response)

Return an error response for a reason why a namespace element (“av1:originalFormat”) which is not compatible with the AV device 1 is used.

(Processing Method 2: Returning an Error Response)

Return a null response for a reason why a namespace element (“av1:originalFormat”) which is not compatible with the AV device 1 is used.

(Processing Method 3: Editing and Sending a Search Operation)

Send a CreateObject operation after an editing process as shown in FIG. 36. In this editing process, a prefix “av1” is replaced with “av”.

According to the above processing methods 1 and 2, a simple responding process suffices, and a processing burden is not required. In contrast, in the case of the processing method 3, a possibility that a request fails according to the content information to be assigned to an argument can be reduced to the minimum. In addition, it is preferable that this method can be compatible with an AV device which is insufficient in processing capability relevant to a namespace by replacing a namespace specification with a prefix which is compatible with an AV device of a query destination.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A content information management apparatus for transmitting first and second queries to first and second content providing devices which provide content information described in extensible mark up language by specifying a namespace, linking first content information provided from the first content providing device having responded to the first query with second content information provided from the second content providing device having responded to the second query thereby to generate a response having a tree structure, and transmitting the response according to a query from another device, the content information management apparatus comprising:
an extractor configured to extract a first namespace declaration description from the first content information and a second namespace declaration description from the second content information;
a detector configured to detect an occurrence of duplication between a first prefix included in the first namespace declaration description and a second prefix included in the second namespace declaration description when both of the which are placed on a most significant node of the tree structure;
a processor configured to process the first and second content information in order to avoid the duplication; and
a response generator configured to generate the response by linking the processed first and second content information.

2. A content information management apparatus according to claim 1, wherein the processor is configured to move the first namespace declaration description to any node in a first partial tree in the tree structure which corresponds to the first content information, and move the second namespace declaration description to any node in a second partial tree in the tree structure which corresponds to the second content information.

3. A content information management apparatus according to claim 1, wherein the processor is configured to eliminate a description relating to the first prefix from the first content information, and eliminate a description relating to the second prefix from the second content information.

4. A content information management apparatus according to claim 1, wherein the processor is configured to replace the first prefix with a third prefix and replace the second prefix with a fourth prefix which is different from the third prefix.

5. A content information management apparatus according to claim 1, further comprising:
a namespace list storage, with respect to each of the first and second content providing devices, to store a namespace list representing a prefix of a namespace and information corresponding to whether or not the prefix is standard;
a determination device to determine whether or not a content providing device corresponding to a destination of the query from the another device can accept the query by correlating a prefix of a namespace included in a query from the another device with the namespace list; and
a reception device configured to accept or reject the query according to a result of the determination by the determination device.

6. A content information management apparatus according to claim 5, wherein the reception device is configured to return an error response to the another device, if it is determined that the content providing device corresponding to the destination cannot accept the query.

7. A content information management apparatus according to claim 5, wherein the reception device is configured to return a null response to the another device, if it is determined that the content providing device corresponding to the destination cannot accept the query.

8. A content information management apparatus according to claim 5, wherein the reception device is configured, if it is determined that the content providing device corresponding to the destination cannot accept the query for a reason why a prefix of a namespace included in a query from the another device is not standard, to eliminate the nonstandard prefix from the prefixes of the namespaces included in the query in order to accept the query.

9. A content information management apparatus according to claim 5, further comprising:
a prefix replacement list storage to store a prefix replacement list for newly replacing a nonstandard prefix with another prefix,
wherein the reception device is configured to replace a nonstandard prefix of the prefixes of the namespaces included in the query from the another device based on the prefix replacement list in order to accept the query.

10. A content information management method for transmitting first and second queries to first and second content providing devices which provide content information described in extensible mark up language by specifying a namespace, linking first content information provided from the first content providing device having responded to the first query with second content information provided from the second content providing device having responded to the second query to generate a response having a tree structure, and transmitting the response according to a query from another device, the content information management method comprising:
extracting a first namespace declaration description from the first content information and a second namespace declaration description from the second content information;
detecting an occurrence of duplication between a first prefix included in the first namespace declaration description and a second prefix included in the second namespace declaration description when the first and second namespace declaration descriptions are placed on a most significant node of the tree structure;
processing the first and second content information in order to avoid the duplication; and
generating a response by linking the processed first and second content information.

11. A content information management method according to claim 10, wherein the processing includes moving the first namespace declaration description to any node in a first partial tree in the tree structure which corresponds to the first content information, and moving the second namespace declaration description to any node in a second partial tree in the tree structure which corresponds to the second content information.

12. A content information management method according to claim 10, wherein the processing includes eliminating a description relating to the first prefix from the first content information, and eliminating a description relating to the second prefix from the second content information.

13. A content information management method according to claim 10, wherein the processing includes replacing the first prefix with a third prefix and replacing the second prefix with a fourth prefix which is different from the third prefix.

14. A content information management method according to claim 10, further comprising:
storing a namespace list with respect to each of the first and second content providing devices, the namespace list representing a prefix of a namespace and information corresponding to whether or not the prefix is standard;
determining whether or not a content providing device corresponding to a destination of the query from the another device can accept the query by correlating a prefix of a namespace included in a query from the another device with the namespace list; and
accepting the query if the query is acceptable, and rejecting the query if the query is not acceptable, according to a result of the determination.

15. A content information management method according to claim 14, further comprising:
storing a prefix replacement list for newly replacing a nonstandard prefix with another prefix,
wherein the accepting includes replacing a nonstandard prefix of the prefixes of the namespaces included in the query from the another device based on the prefix replacement list in order to accept the query.

16. A program product for transmitting first and second queries to first and second content providing devices which provide content information described in extensible mark up language by specifying a namespace, linking first content information provided from the first content providing device having responded to the first query with second content information provided from the second content providing device having responded to the second query to generate a response having a tree structure, and transmitting the response according to a query from another device, the program product comprising:
first means for instructing a computer to extract a first namespace declaration description from the first content information and extract a second namespace declaration description from the second content information;
second means for instructing the computer to detect an occurrence of duplication between a first prefix included in the first namespace declaration description and a second prefix included in the second namespace declaration description, when the first and second namespace declaration descriptions are placed on a most significant node of the tree structure;
third means for instructing the computer to process the first and second content information in order to avoid the duplication; and
fourth means for instructing the computer to generate the response by linking the processed first and second content information.

17. A program product according to claim 16, wherein the third means includes means for instructing the computer to move the first namespace declaration description to any node in a first partial tree in the tree structure which corresponds to the first content information, and move the second namespace declaration description to any node in a second partial tree in the tree structure which corresponds to the second content information.

18. A program product according to claim 16, wherein the third means includes means for instructing the computer to eliminate a description relating to the first prefix from the first content information, and eliminate a description relating to the second prefix from the second content information.

19. A program product according to claim 16, wherein the third means includes means for instructing the computer to replace the first prefix with a third prefix and replace the second prefix with a fourth prefix which is different from the third prefix.

20. A program product according to claim 16, further comprising:
fifth means for instructing the computer to store a namespace list with respect to each of the first and second content providing devices, the namespace list representing a prefix of a namespace and information corresponding to whether or not the prefix is standard;
seventh means for instructing the computer to determine whether or not a content providing device corresponding to a destination of the query from the another device can accept the query, by correlating a prefix of a namespace included in a query from the another device with the namespace list; and
eighth means for instructing the computer to accept or reject the query, according to a result of the determination.

21. A content information management program product according to claim 16, further comprising:
ninth means for instructing the computer to store a prefix replacement list for newly replacing a nonstandard prefix with another prefix,
wherein the eighth means includes means for instructing the computer to replace a nonstandard prefix of the prefixes of the namespaces included in the query from the another device based on the prefix replacement list in order to accept the query.
